(19) United States
(12) Patent Application Publication
(10) Pub. No.: US 2005/0129366 A1
(43) Pub. Date: Jun. 16, 2005

(54) Graded index optical coupler

(76) Inventor: John Yasaitis, Lexington, MA (US)

Correspondence Address: BROMBERG & SUNSTEIN LLP, 125 SUMMER STREET, BOSTON, MA, 02110-1618, US

(21) Appl. No.: 10/735,410

(22) Filed: Dec. 12, 2003

(51) Int. Cl. G02B 6/26

(52) U.S. Cl. 385/39; 385/15; 385/28

(57) ABSTRACT

A coupler for coupling light in an optical system is described. Multiple discrete layers of alternating optical materials have respective first and second indexes of refraction. The thickness of each layer is a fraction of the light wavelength.

### FIELD OF THE INVENTION

The invention generally relates to optical coupling, specifically between single mode optical fiber and a silicon waveguide.

### BACKGROUND ART

Single mode optical fiber (SMF) has a core typically made of doped silicon dioxide (SiO₂, also known as silica) having a refractive index of around 1.45. The remainder of the fiber is generally a thick cladding of pure silicon dioxide. The refractive index of the cladding may be around 1.447. The difference in the refractive indexes of the core and cladding is relatively small, ˜⅓%. Thus, SMF is said to have a low index contrast.

In a planar waveguide, a planar core material such as silicon nitride (Si₃N₄) or silicon oxynitride (SiON) is surrounded by a cladding of another material such as silicon dioxide. The refractive index of the core may be around 2.2 and that of the cladding 1.45, so that the difference between the refractive indices is relatively large. Thus, planar waveguides are said to have a high index contrast (HIC).

In optical systems, the need arises to couple light between low index contrast SMF and HIC waveguides (WG). It is desirable that any such coupling be as efficient as possible to minimize energy loss. An optical mode converter to efficiently couple light between SMF and HIC WG can utilize a graded index mode converter in which the refractive index of the coupler is graded in a direction perpendicular to the optical propagation path.

FIG. 1 shows an example of a graded index mode coupler according to the prior art. Single mode fiber 10 has a core 11 about 8.5 μm in diameter, made of doped silicon dioxide having a refractive index of about 1.45. The core 11 is surrounded by a thick cladding 12 of pure silicon dioxide having an outside diameter of 125 μm. HIC WG 13 includes a silicon-rich silicon nitride core 14 having a refractive index of 2.2, covered by relatively thick layers of cladding 15 and supported by a silicon wafer substrate 16 based on materials commonly used in silicon-based IC manufacturing. The optical signal is coupled between the SMF core 11 and the HIC WG core 14 by a section of graded index coupler 17.

Coupler 17 may be made of silicon oxynitride with a continuously varying stoichiometry (i.e., nitride ratio) that increases from top to bottom, for example, from 10 to 25 to 50%. This progressively graded increase in the nitride ratio of the coupler 17 results in a transition in refractive indices that increases from that of the optical fiber core 11 (˜1.45) to that of the HIC WG core 14 (e.g., 2.2 for silicon rich silicon nitride). This is the approach used, for example, in graded mode couplers to oxynitride and nitride HIC waveguides.

But some HIC waveguides have a core of pure silicon (HIC Si WG), needed for example, for integrated external laser modulators. Pure silicon has a refractive index of 3.5. Thus, there is the problem that no materials used in conventional silicon IC's have a refractive index between 2.2 and 3.5. Due to the unavailability of practical materials with refractive indexes in this range, graded index couplers are not known for coupling HIC Si WG to SMF.

There is another known technique to couple HIC Si WG to SMF. In a taper coupler, the HIC Si WG is tapered to very small dimensions next to the fiber to expand the waveguide mode to match the fiber. However, this technique requires very fine lithography and is not very efficient.

### SUMMARY OF THE INVENTION

A representative embodiment of the present invention includes a coupler for coupling light in an optical system, and a corresponding method of coupling light. Multiple discrete layers of alternating optical materials have respective first and second indexes of refraction. The thickness of each layer is a fraction of the light wavelength. For example, the fraction may be about 1/10 and the materials maybe silicon and silicon nitride or silicon-rich nitride.

### BRIEF DESCRIPTION OF THE DRAWINGS

FIG. 1 shows a graded index mode optical coupler according to the prior art.

FIG. 2 shows a graded index mode optical coupler according to one embodiment of the present invention.

FIG. 3 shows in expanded detail the thin layers of materials used in one embodiment.

### DETAILED DESCRIPTION OF SPECIFIC EMBODIMENTS

Embodiments of the present invention are directed to a graded optical index coupler that couples between single mode optical fiber (SMF) and high index contrast (HIC) Silicon waveguides (Si WG). Practical materials that can be used in standard silicon IC processing are utilized in a novel layering technique to provide the missing gap in refractive index for an index graded coupler between SMF and HIC Si WG's. Sub-wavelength layering of materials having different optical indices produces an effective index grading through the range between the two different indices.

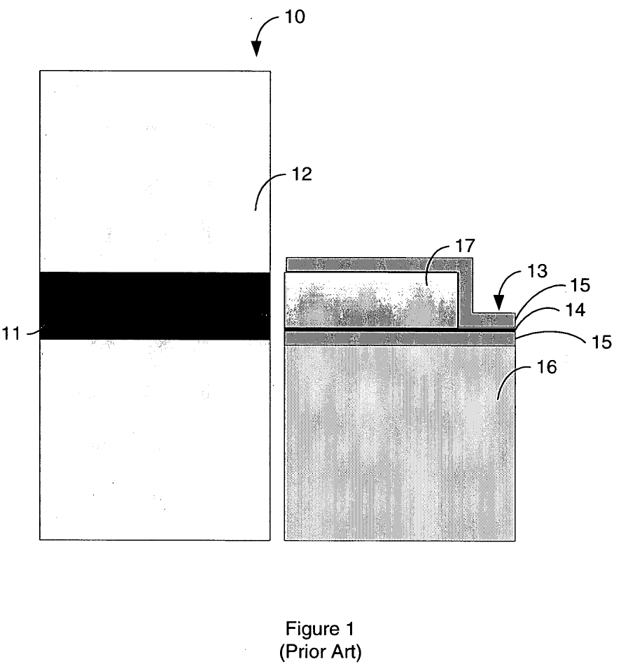

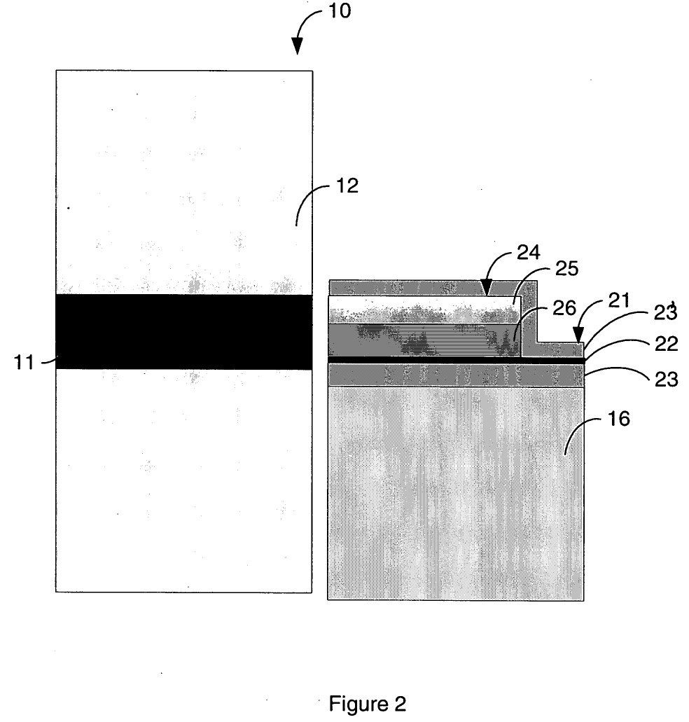

FIG. 2 shows a graded index coupler according to one embodiment of the present invention. The left side is the same as for FIG. 1, with a single mode fiber 10 having an optical core 11 surrounded by a layer of thick cladding 12. HIC Si WG 21 includes a pure silicon core 22 covered by relatively thick layers of cladding 23 and supported by substrate 16. Coupler 24 has an upper section 25 and a lower section 26. Upper section 25 is similar to the prior art graded index coupler described with respect to FIG. 1, providing refractive indexes between the fiber core of 1.45 and 2.2 by oxynitride layers with increasing nitride ratios as described above. Bottom section 26 provides an effective index of refraction covering the range of 2.2 to 3.5.

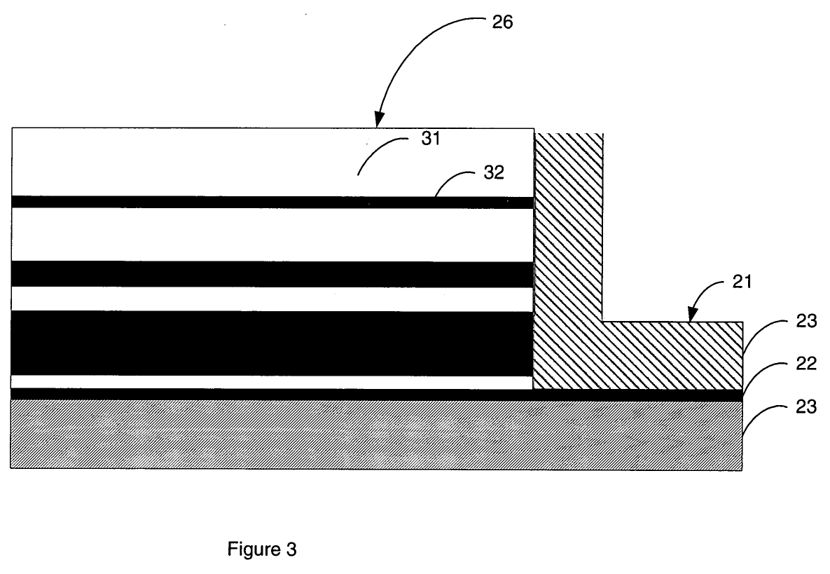

FIG. 3 shows in bottom section 26 in expanded detail. Bottom section 26 sandwiches multiple very thin layers of silicon nitride 31 (or silicon rich nitride) and pure silicon 32, where the thickness of each layer is just a small fraction of the wavelength of light propagating in the system. For example, in one specific embodiment, the thickness of each layer is less than one tenth the wavelength of the light. The ratio and the number and thickness of the layers are adjusted to provide an effective vertical grading of index over the desired range. By using such thin layers of materials, at the magnitude of the light wavelength the coupler appears to possess smoothly graded indexes of refraction as desired.

Although the invention has been described with respect to covering the range of refractive indexes between 2.2 and 3.5, its principle can be used more broadly. By using other materials with different refractive indexes, and controlling the ratio and the number and thickness of the layers, other ranges of refractive indexes can be provided.

Thus, although various exemplary embodiments of the invention have been disclosed, it should be apparent to those skilled in the art that various changes and modifications can be made which will achieve some of the advantages of the invention without departing from the true scope of the invention.

1. A coupler for coupling light in an optical system, the coupler comprising:
a plurality of discrete layers of alternating optical materials having respective first and second indexes of refraction for coupling light of a given wavelength, the thickness of each layer being a fraction of the light wavelength.

2. A coupler according to claim 1, in which the fraction is about 1/10.

3. A coupler according to claim 1, in which the materials are silicon and silicon nitride.

4. A coupler according to claim 1, in which the materials are silicon and silicon rich nitride.

5. A method for coupling light in an optical system comprising:
providing a plurality of discrete layers of alternating optical materials having respective first and second indexes of refraction for coupling light of a given wavelength, the thickness of each layer being a fraction of the light wavelength.

6. A method according to claim 5, in which the fraction is about 1/10.

7. A method according to claim 5, in which the materials are silicon and silicon nitride.

8. A method according to claim 5, in which the materials are silicon and silicon rich nitride.
